(19) United States
(12) Patent Application Publication
(10) Pub. No.: US 2020/0061927 A1
(43) Pub. Date: Feb. 27, 2020

(54) System and Methods for Using Three Dimensional Printing to Fabricate Contoured Dividers

(71) Applicant: Walmart Apollo, LLC, Bentonville, AR (US)

(72) Inventors: Andrew B. Millhouse, Gilbert, AZ (US); John S. Meredith, Bentonville, AR (US); Timothy J. Burleson, Bentonville, AR (US)

(21) Appl. No.: 16/545,639

(22) Filed: Aug. 20, 2019

Related U.S. Application Data
(60) Provisional application No. 62/720,295, filed on Aug. 21, 2018.

(51) Int. Cl. B29C 64/393; B33Y 30/00; B33Y 50/02; B29C 64/20; B65D 90/00; B33Y 80/00; G05B 19/4093

(52) U.S. Cl. CPC B29C 64/393; B33Y 30/00; B33Y 50/02; B29L 2031/776; B65D 90/0066; B33Y 80/00; G05B 19/40932; B29C 64/20

(57) ABSTRACT

Described in detail herein is a system for fabricating contoured divider walls using a 3D printer. The system includes a vehicle trailer that has a storage volume. The storage volume is configured to store pallets. Sensors are configured to identify physical attributes associated with the storage volume and each of the pallets. The system can further include a 3D printing device and a computing system coupled to the sensors and the 3D printing device. The computing system is configured to receive the physical attributes of the storage volume and each of the pallets, to divide the pallets into multiple sets of pallets based on position of each of the pallets in the storage volume, to determine a contour shape of each set of pallets in the multiple sets of pallets, and to transmit a first set of instructions instructing the 3D printing device to fabricate one or more divider walls for a set of pallets.

### RELATED APPLICATION

This application claims priority to, and the benefit of, U.S. Provisional Patent Application No. 62/720,295, filed Aug. 21, 2018, the contents of which are incorporated herein by reference in their entirety.

### BACKGROUND

Physical objects stored in vehicle trailers are frequently stored on pallets for transport. The physical objects can fall over and break while the vehicle is in motion.

### BRIEF DESCRIPTION OF THE FIGURES

Illustrative embodiments are shown by way of example in the accompanying figures and should not be considered as a limitation of the present disclosure. The accompanying figures, which are incorporated in and constitute a part of this specification, illustrate one or more embodiments of the invention and, together with the description, help to explain the invention. In the figures:

FIG. 1 is a block diagram of a vehicle trailer loaded with physical objects in accordance with an exemplary embodiment;

FIG. 2 illustrates an exemplary panel to surround a side of a loaded pallet in accordance with an exemplary embodiment;

FIGS. 3A-B is a block diagram of dividers separating pallets inside a vehicle trailer in accordance with an exemplary embodiment;

FIG. 4 illustrates an exemplary 3D printer in accordance with an exemplary embodiment;

FIG. 5 illustrates a network diagram of a system for fabricating contoured divider walls in accordance with an exemplary embodiment;

FIG. 6 illustrates a block diagram an exemplary computing device in accordance with an exemplary embodiment; and

FIG. 7 is a flowchart illustrating the process implementing the system for fabricating contoured divider walls.

### DETAILED DESCRIPTION

Described in detail herein is a system for fabricating contoured divider walls using a 3D printer. In one embodiment, the system includes a vehicle trailer including a storage volume formed by a floor, a top wall, a first side wall, a second side wall and a back wall. The storage volume is configured to store pallets. Each pallet is configured to support physical objects of various shapes and sizes. Sensors can be disposed within or with respect to the storage volume of the vehicle trailer. The sensors are configured to identify physical attributes associated with the storage volume and each of the pallets. The system can further include a 3D printing device and a computing system coupled to the sensors and the 3D printing device. The computing system is configured to receive the physical attributes of the storage volume and each of the pallets, to divide the pallets into multiple sets of pallets based on position of each of the pallets in the storage volume, to determine a contour shape of each set of pallets of the multiple sets of pallets, and to transmit a first set of instructions instructing the 3D printing device to fabricate one or more divider walls extending from either the floor of the storage volume to the top wall of the storage volume or between the first side wall and the second side wall of the storage volume. Each divider wall can be fabricated to have the contour shape of the items along an edge of each set of pallets based on the physical attributes of the items and pallets received from the sensors.

In one embodiment a method for fabricating contoured divider walls includes storing, via storage volume formed by a floor, a top wall, a first side wall, a second side wall and a back wall of a vehicle trailer multiple pallets, each pallet configured to support physical objects of various shapes and sizes. The method also includes identifying, via sensors disposed within or with respect to the storage volume of the vehicle trailer, physical attributes associated with the storage volume and each of the pallets and receiving, via a computing system, coupled to the sensors and a 3D printing device, the physical attributes of the storage volume and each of the pallets. The method additionally includes dividing, via the computing system, the pallets into multiple sets of pallets based on position of each of the pallets in the storage volume and determining, via the computing system, a contour shape of each set of pallets of the multiple sets of pallets. Additionally the method includes transmitting, via the computing system, a first set of instructions instructing the 3D printing device to fabricate one or more divider walls extending from either the floor of the storage volume to the top wall of the storage volume or between the first side wall and the second side wall of the storage volume, each divider wall having the contour shape of the items along an edge of each set of pallets.

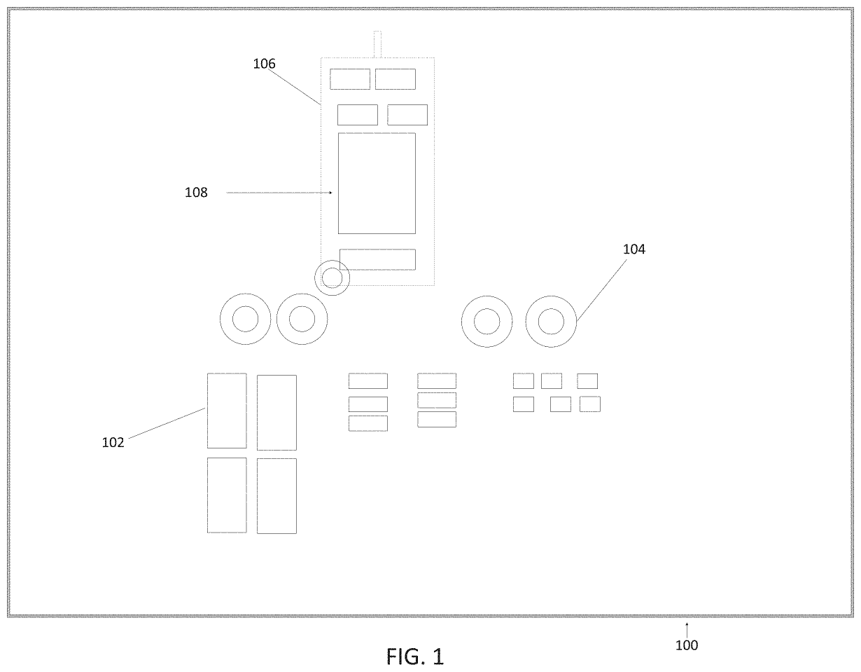

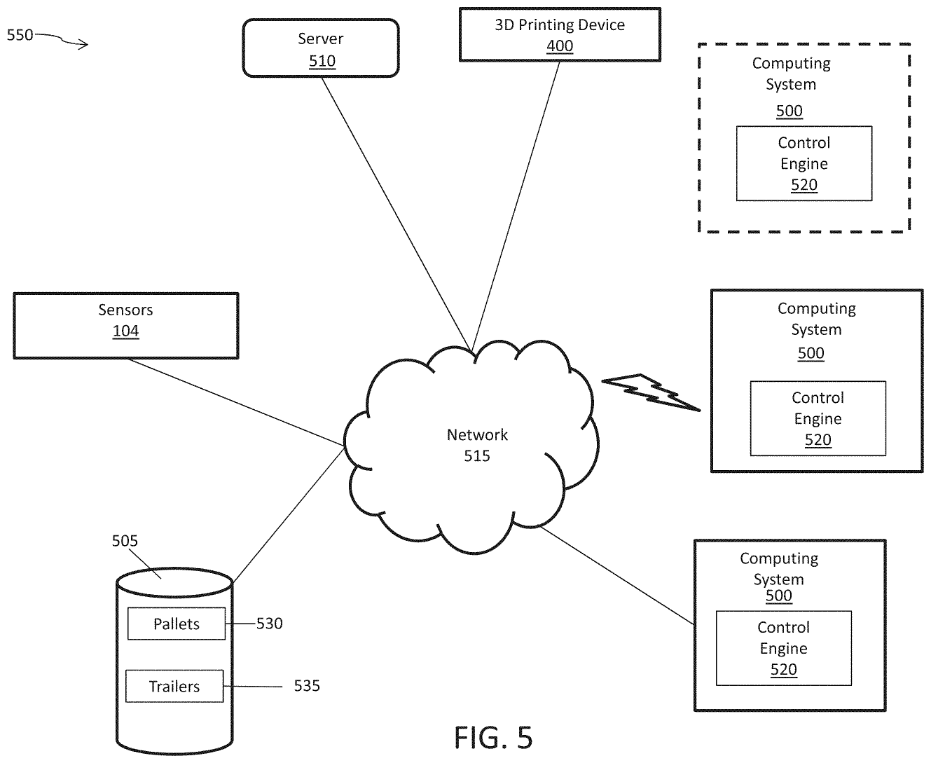

FIG. 1 is a block diagram of a vehicle trailer loaded with pallets supporting physical objects in accordance with an exemplary embodiment. In one embodiment, pallets 102 stacked with physical objects can be disposed in a facility 100. The pallets 102 can be of various sizes in height, width, and length. The pallets 102 can be disposed in a loading dock area of the facility 100. The loading dock area can also include vehicle trailers 106 including a storage volume 108 to store the pallets 102. Sensors 104 can be disposed within and with respect to the vehicle trailer 106 and the storage volume 108. The sensors 104 can be configured to capture physical attributes of physical objects and the pallets 102. In one embodiment, one or more of the sensors 104 may be imaging devices. Alternatively, one or more of the sensors 104 may be lidar sensors, heat sensors, motion sensors, charged coupled device (CCD) sensors, CMOS sensors, bayer filter sensor, x-ray, temperature sensors, ultrasonic sensors, capacitive sensors, pressure sensor, light sensor, proximity sensors, infrared sensors, or light sensor. In one embodiment, the sensors may also capture physical attributes of the storage volume 108. For example, the sensors 100 can capture one or more of the size, dimensions, volume, and weight of the pallets 102 and their physical objects and capture physical attributes of empty space in the storage volume 108, and/or other physical attributes associated with the pallets 102, items and the storage volume 108. In one embodiment, the sensors 108 can capture the physical attributes of the pallets 108 and their items while the pallets are disposed outside the storage volume 108. Alternatively, or in addition to the sensors 108 can capture the physical attributes associated with the pallets 102 and their items while the pallets 102 are disposed within the storage volume 108. The sensors 108 can also capture the physical attributes associated with the space between the pallets 102 stored in the storage volume 108. In one embodiment, the sensors 108 can be instructed to capture the information by a communicatively coupled computing system. Alternatively, or in addition to the sensors 108 can capture the information after a specified amount of time. The sensors 108 can transmit the captured information to the computing system. The computing system will be described in greater detail with respect to FIG. 5.

In one embodiment, the storage volume 108 of the vehicle trailer 106 is a known value and does not need to be measured by the sensors 108. In another embodiment, the sensors 108 measure the storage volume 108 to account for a vehicle trailer 106 that is partially filled before the loading process at the facility.

In an embodiment, instead of the sensors acquiring physical attributes of the pallets and physical objects at a loading dock, the sensors may be deployed within the storage volume or within range of the storage volume and may identify physical attributes of the pallets and their physical objects after the pallets and physical objects have been loaded into the vehicle trailer 106.

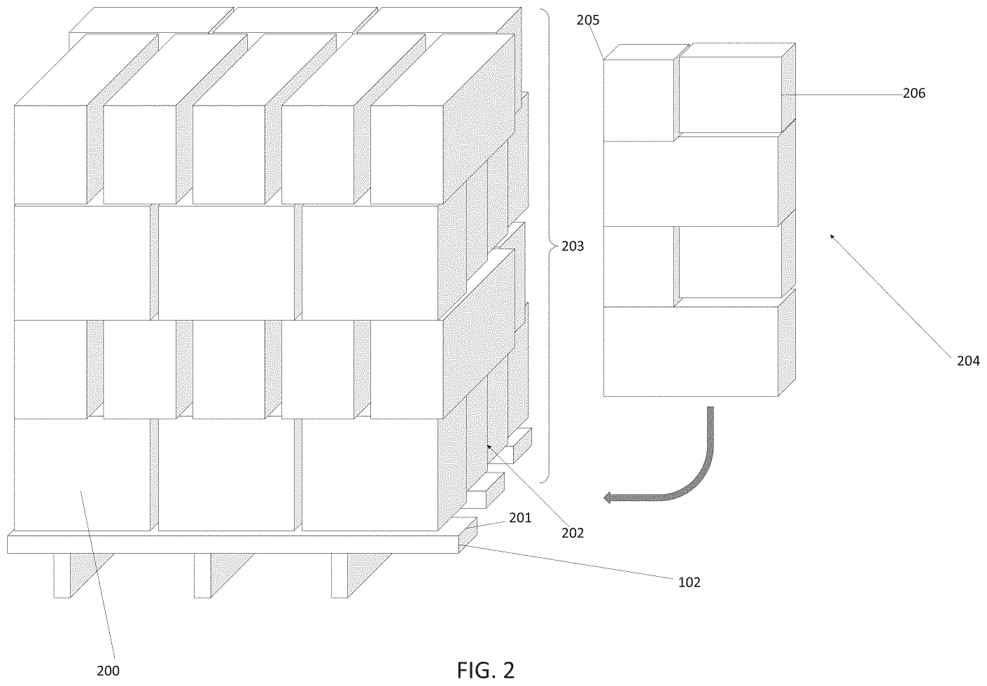

FIG. 2 illustrates an exemplary panel to surround a side of a loaded pallet in accordance with an exemplary embodiment. As described above, a pallet 102 can support physical objects 200. The physical objects 200 can be stacked vertically and disposed laterally along the surface 201 of the pallet 102. The stack 203 of physical objects 200 can have four sides. For example, the stack 203 can have a side 202. The stack 203 may include physical objects of various sizes and shapes at each side. The stack 203 of physical objects 200 may be prone to fall or tip on any of the four sides. To prevent the tipping or falling of the physical objects 200, a contoured panel 204 can be mounted on any of the sides (i.e., side 202). The contoured panel 204 can contoured based on the size and shape of the physical objects on the respective side of the stack 203. For example, the contoured panel 204 can include protrusions 205 and indentations 206 to account for physical objects 200 sticking out of the side 202, or not fully extending to the end of the side 202. The contoured panel 204 can extend from the bottom of the stack 203 to the top of the stack. Alternatively or in addition to, the contoured panel 204 can extend from the bottom of the pallet 102 to the top of the stack 203.

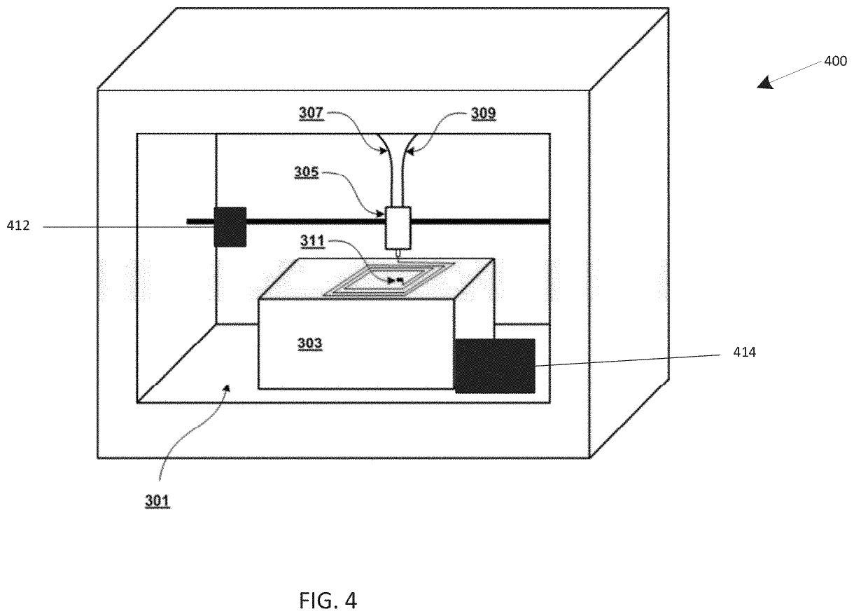

In one embodiment, a contoured panel 204 can be mounted on each side of the stack 203. The contoured panel 204 on each side of the stack 203 can be coupled to one another using a coupling member. In the event the contoured panels 204 for each side of the stack 203 are coupled to one another, the contoured panels can fit over the stack 203 like a sleeve. As described above, in response to mounting the contoured panels 204, the physical objects 200 in the stack 203 can be prevented from tipping/falling. Each of the contoured panels 204 can be fabricated using a 3D printer based on the physical attributes detected for the physical objects in the stack 203. The 3D printer will be described in further detail with respect to FIG. 4.

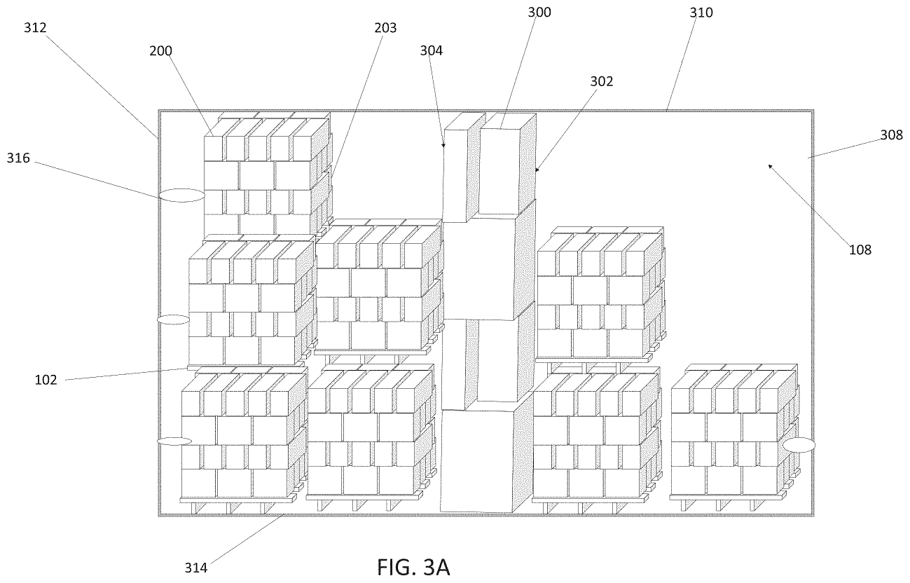

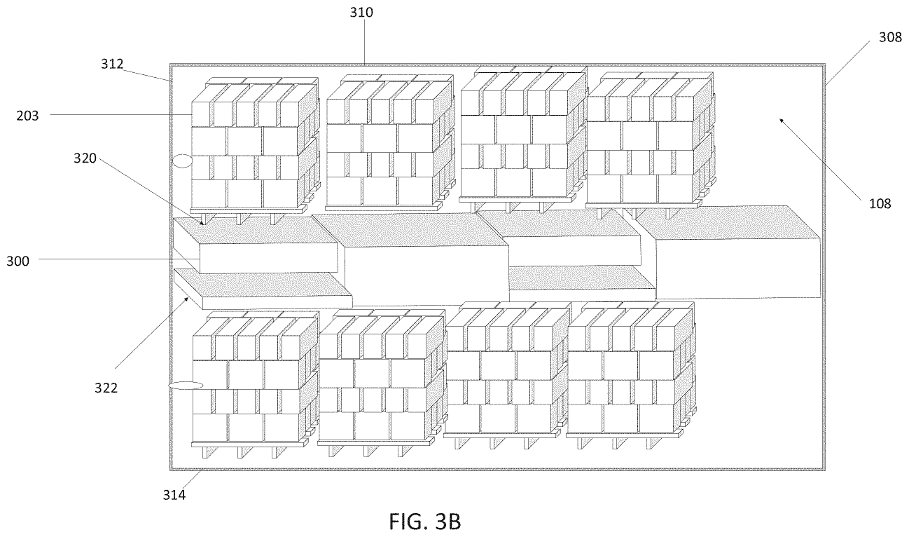

FIGS. 3A-B are block diagrams of dividers separating pallets inside a vehicle trailer in accordance with an exemplary embodiment. With reference to FIG. 3A, the storage volume 108 of the vehicle trailer can store pallets 102 supporting stacks 203 of physical objects 200. The pallets 102 can be stacked on top of one another vertically, and can be disposed laterally. A front side 308, a top wall 310, a back side 312, a floor 314, a first side wall (not shown), and a second side wall (not shown) can form the storage volume 108. The front side 308 can include a door to provide access to the storage volume 108. A contoured divider wall 300 can be disposed between the stacks of pallets 102. The contoured divider wall 300 can include a first side 302 and a second side 304. The first side 302 of the contoured divider wall 300 can be contoured to the shape of the stack 203 of physical objects 200 on each of the pallets 102 facing and immediately adjacent to the first side 302. The second side 304 of the contoured divider wall 300 can be contoured to the shape of the stack 203 of physical objects on each of the pallets 102 facing and immediately adjacent to the second side 304. The contoured divider wall 300 can include protrusions and indentations to account for the various shapes formed by the stacks 203 of physical objects on the pallets 102 and the stacks of pallets 102. The contoured divider wall 300 can extend from the floor 314 to the top wall 310 of the storage volume 108 and from the first side wall to the second side wall of the storage volume 108. The width of the contoured divider wall 300 can be of a specified size. It can be appreciated that the contoured divider wall 300 can reside at any position in the storage volume 108. Attachment mechanisms 316 can be coupled to one or more of the pallets 102 adjacent to the front side 308, top wall 310, back side 312 and/or floor 314. The attachment mechanisms 315 can secure the respective pallet 102 to the front side 308, top wall 310, back side 312 and/or floor 314 of the storage volume 108.

With reference to FIG. 3B, the contoured divider wall 300 can extend laterally from the front side 308 to the back side 312. The contoured divider wall 300 can include a third side 320 and a fourth side 322. The third side 320 can of the contoured divider wall 300 can be contoured to the shape of the stack 203 of physical objects 200 on each of the pallets 102 immediately above to the third side 320. The fourth of the contoured divider wall 300 can be contoured to the shape of the stack 203 of physical objects on each of the pallets 102 immediately below to the fourth side 322.

With reference to FIGS. 3A-3B, the contoured divider wall 300 can also be in a shape of an L, square, circle, curved, any other shape. The contoured divider wall 300 can also be disposed diagonally across the storage volume 108. The contoured divider wall 300 and attachment mechanisms 316 can be fabricated using a 3D printer. The 3D printer will be described in further detail with respect to FIG. 4.

FIG. 4 shows an example 3D printer 400 for printing a three dimensional physical object 403 In this example embodiment, the 3D printer 400 includes an extruder 405 or 3D printer head that is configured to receive one or more spools or filaments of material (e.g., a first material 407 and a second material 409). The extruder 405 can selectively extrude the material to print the three dimensional product 403 on a print bed 401. The print bed 401 can be heated or unheated. The one or more materials fed into the extruder 405 can include the plastic or resin (and/or other materials) to fabricate the three-dimensional physical object 403. One or more motors 412 can control the motion of the extruder 405. A controller 414 and can be operatively coupled to the extruder 405, the one or more motors 412, and print bed 401. The controller 414 can control the operations of the one or more motors 412, the extruder 405, and the print bed 401.

The controller 414 can receive instructions to fabricate an instance of the three-dimensional physical object 403 based on a representation of the physical object as described herein. In some embodiments, the extruder can heat and melt the one or more materials before dispensing the material on the print bed 401 and/or can sinter the material as it is deposited on the print bed 301. In some embodiments, the extruder 405 can include a motor, a fan, a heat sink, a thermistor, a heating block, and a nozzle. The material can be dispensed through the nozzle after being heated by the heating block.

The controller 414 can control the one or more motors to control the motion of the extruder 405 to generate the structure of the instance of the three-dimensional physical object 403 on the print bed 401. The one or more motors 414 can move the extruder 405 along three axes, e.g., the X, Y and Z axis. Alternatively, the extruder 405 can be suspended using three arms, and the arms can move along the X, Y and Z axis at different rates.

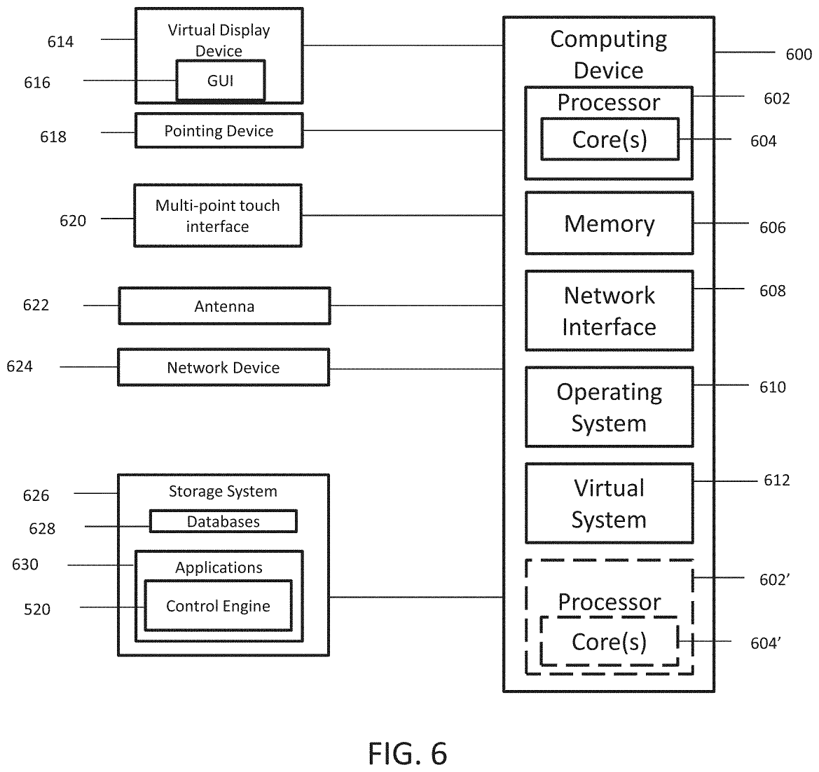

The 3D printer can fabricate the contoured panel (e.g., contoured panel 204 as shown in FIG. 2) or the contoured divider wall (e.g., contoured divider wall 300 as shown in FIG. 3) based on instructions received by a computing system. The computing system will be described in greater detail with respect to FIG. 6. The contoured panel and divider can be fabricated in materials such as aluminum, plastic, or textile softwall.

FIG. 5 illustrates a network diagram of a system 550 for fabricating contoured divider walls in accordance with an exemplary embodiment. The system 550 for fabricating contoured divider walls can include one or more databases 505, one or more computing systems 500, one or more 3D printing devices 400, and one or more sensors 104. The computing system 500 can be in communication with the databases 505, the 3-D printing devices 400, and the sensors 104 via a communications network 515. The computing system 500 can implement at least one instance of a control engine 520. The control engine 520 can be an executable application executed on the computing system 500. The control engine 520 can execute the process the system 550 for fabricating contoured divider walls as described herein.

In an example embodiment, one or more portions of the communications network 515 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The computing system 500 includes one or more computers or processors configured to communicate with the databases 505, the 3-D printing devices 400, servers 510 and the sensors 104. The databases 505 can store information/data, as described herein. For example, the databases 505 can include a pallets database 530 and a trailers database 535. The pallets database 530 can store information associated with different pallets such as size, physical objects disposed on the pallet and an amount a pallet could support. The trailers database 535 can store information associated with the vehicle trailers, such as size, the pallets loaded on the trailers and volume information. The databases 505 and the computing system 500 can be located at one or more geographically distributed locations from each other. Alternatively, the databases 505 can be included within the computing system 500.

In one embodiment, the sensors 104 can be disposed within or with respect to a vehicle trailer (e.g., vehicle trailer 106 as shown in FIG. 1). The sensors 104 can detect the shape, size, volume, and other attributes associated with the storage volume of the vehicle trailer and the pallets and their respective physical objects (e.g., pallets 102 as shown in FIGS. 1, 2, 3A-B) disposed within the storage volume of the vehicle trailer. The attributes can also include the space between pallets and the space between the pallets and the walls of the storage volume. The pallets can be supporting physical objects stacked vertically, and disposed laterally along the pallet. The sensors 104 can transmit the detected attributes associated with the storage volume and the pallets to the computing system 500. In response to receiving the attributes, the computing system can execute the control engine 550.

The control engine 550 can receive the detected attributes associated with the pallets and storage volume of the vehicle trailer. The control engine 550 can query pallets database 530 and the trailers database 535 to retrieve further information associated with the pallets and trailers. The information can include the type of physical objects disposed on the pallet, the size of the physical objects, the shape of the physical objects, and the size of the storage volume of the trailer. In one embodiment, the information can also include an expected destination of the vehicle trailer.

The control engine 550 can divide the storage volume of the vehicle trailer into multiple different sections based on the information and attributes associated with the pallets and storage volume of the vehicle trailer. The multiple different sections can include multiple pallets including stacks of physical objects. Each pallet can be of a different shape or size.

The control engine 550 can instruct the 3D printing device 400 to fabricate a contoured divider wall (e.g., contoured divider wall 300 as shown in FIGS. 3A-B) and/or a contoured panel (e.g., contoured panel 204) based on the detected attributes associated with the pallets and their physical objects and trailers, along with the retrieved information associated with the pallets and physical objects and the trailers. The contoured divider wall can divide (or partition) the first and second section of the multiple sections of the storage volume of the vehicle trailer. The contoured divider wall includes a contoured side facing a first section and a contoured side facing a second section. The contoured side facing the first section can be contoured to the pallets immediately adjacent to the contoured divider wall in the first section. The countered side facing the first section can also be contoured to the empty space between the pallets and between the walls and the pallets. The contoured side facing the second section can be contoured to the pallets immediately adjacent to the contoured divider wall in the second section. The contoured side facing the second section can also be contoured to the empty space between the pallets and between the pallets and the walls of the storage volume. The countered divider can be configured to prevent the pallets from each section from tipping, moving, or falling over. The contoured divider walls can extend from the top wall to the floor of the storage volume from a first side wall to a second side wall of the storage volume. Alternatively or in addition to, the contoured divider walls can extend from the front door to the back wall horizontally. It should be appreciated that the contoured divider wall and the sections within the storage volume may be many different shapes or sizes.

The countered panel can be contoured to a side of a pallet supporting physical objects. The contoured panel can be mounted to a side of the pallet to prevent the physical objects stacked on the pallet from tipping or falling over. Multiple contoured panels can be fabricated for a single pallet to be mounted on each side of the pallet. Each contoured panel can be contoured specifically to each side of the pallet. The contoured panels can be configured to be attached to one another. The contoured panels can fit over pallet supporting a stack of physical objects like a sleeve.

In one embodiment, the control engine 520 can instruct the 3D printing device 400 to fabricate coupling devices (e.g., coupling device 316 as shown in FIGS. 3A-B). The coupling devices can be handles, latches, fasteners, bolts or other attachment mechanisms. The coupling device can be secured to a pallet and/or a front, back, first side, second side, or floor. The coupling device can secure a pallet to a front, back, first side, second side, or floor, to prevent the movement of the pallet.

In one embodiment, the 3D printing device 400 can be disposed inside the storage volume of the vehicle trailer to print the contoured divider walls and/or panels inside the storage volume, in response to receiving instructions from the control engine 520. Alternatively, the 3D printing device 400 can be disposed outside the storage volume of the vehicle trailer.

As a non-limiting example, the system 550 for fabricating contoured divider walls can be implemented in a retail store environment. The vehicle trailers can be configured to store and deliver products for sale. Additionally, the pallets can be configured to store the products. The products can be delivered to customers, retail stores, or warehouses.

FIG. 6 is a block diagram of an example computing device for implementing exemplary embodiments of the present disclosure. The computing device 600 may be, but is not limited to, a smartphone, laptop, tablet, desktop computer, server or network appliance. The computing device 600 can be embodied as part of the computing system. The computing device 600 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 606 included in the computing device 600 may store computer-readable and computer-executable instructions or software (e.g., applications 730 such as the control engine 520) for implementing exemplary operations of the computing device 600. The computing device 600 also includes configurable and/or programmable processor 602 and associated core(s) 604, and optionally, one or more additional configurable and/or programmable processor(s) 602′ and associated core(s) 604′ (for example, in the case of computer systems having multiple processors/cores), for executing computer-readable and computer-executable instructions or software stored in the memory 606 and other programs for implementing exemplary embodiments of the present disclosure. Processor 602 and processor(s) 602′ may each be a single core processor or multiple core (604 and 604′) processor. Either or both of processor 602 and processor(s) 602′ may be configured to execute one or more of the instructions described in connection with computing device 600.

Virtualization may be employed in the computing device 600 so that infrastructure and resources in the computing device 600 may be shared dynamically. A virtual machine 612 may be provided to handle a process running on multiple processors so that the process appears to be using only one computing resource rather than multiple computing resources. Multiple virtual machines may also be used with one processor.

Memory 606 may include a computer system memory or random access memory, such as DRAM, SRAM, EDO RAM, and the like. Memory 606 may include other types of memory as well, or combinations thereof.

A user may interact with the computing device 600 through a visual display device 614, such as a computer monitor, which may display one or more graphical user interfaces 616, multi touch interface 620, a pointing device 618, an image capturing device 634 and a scanner 632.

The computing device 600 may also include one or more computer storage devices 626, such as a hard-drive, CD-ROM, or other computer readable media, for storing data and computer-readable instructions and/or software that implement exemplary embodiments of the present disclosure (e.g., applications). For example, exemplary storage device 626 can include one or more databases 628 for storing information regarding pallets and trailers. The databases 628 may be updated manually or automatically at any suitable time to add, delete, and/or update one or more data items in the databases.

The computing device 600 can include a network interface 608 configured to interface via one or more network devices 624 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 622 to facilitate wireless communication (e.g., via the network interface) between the computing device 600 and a network and/or between the computing device 600 and other computing devices. The network interface 608 may include a built-in network adapter, network interface card, PCMCIA network card, card bus network adapter, wireless network adapter, USB network adapter, modem or any other device suitable for interfacing the computing device 600 to any type of network capable of communication and performing the operations described herein.

The computing device 600 may run any operating system 610, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the computing device 600 and performing the operations described herein. In exemplary embodiments, the operating system 610 may be run in native mode or emulated mode. In an exemplary embodiment, the operating system 610 may be run on one or more cloud machine instances.

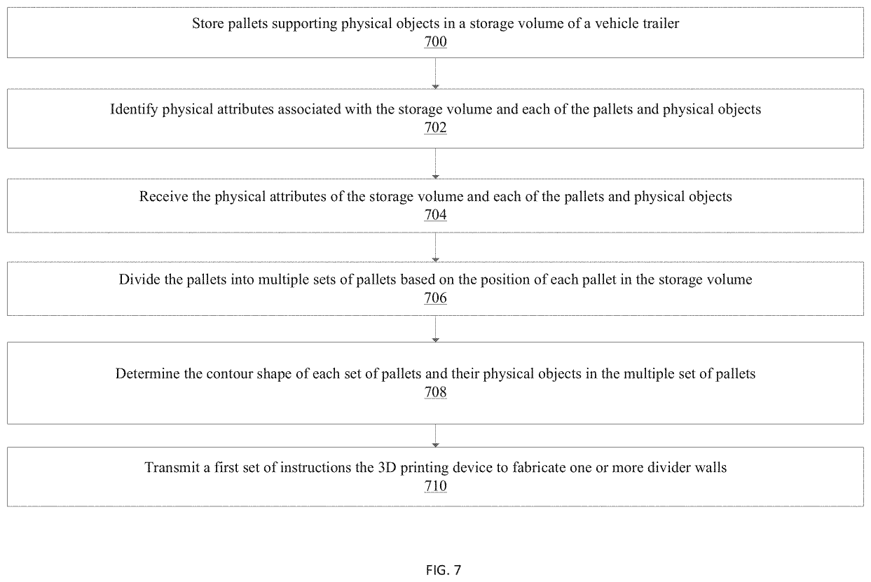

FIG. 7 is a flowchart illustrating the process of the system for fabricating contoured divider walls. In operation 700, a vehicle trailer (e.g., vehicle trailer 106 as shown in FIG. 1) including a floor (e.g., floor 314 as shown in FIGS. 3A-B), top wall (e.g., top wall 310 as shown in FIGS. 3A-B), first side wall, second side wall, a back wall (e.g., back wall 312 as shown in FIGS. 3A-B) forms a storage volume (e.g., storage volume 108 as shown in FIGS. 1 and 3A-B) that stores pallets (e.g., pallets 102 as shown in FIGS. 1-3B) in the storage volume. Each pallet can support physical objects (e.g., physical objects 200 as shown in FIGS. 2-3B) of various shapes and sizes. In operation 702, sensors (e.g., sensors 104 as shown in FIG. 1) disposed within or with respect to the storage volume of the vehicle trailer, can identify physical attributes associated with the storage volume and each of the pallets and their associated physical objects. In operation 704, a computing system (e.g., computing system 500 as shown in FIG. 5) coupled to the sensors and a 3D printing device (e.g., 3D printing device 400 as shown in FIGS. 4-5) can receive the physical attributes of the storage volume and each of the pallets and their associated physical objects. In operation 706, the computing system can divide the pallets into multiple sets of pallets based on the position of each pallet in the storage volume. In operation 708, the computing system can determine the contour shape of each set of pallets and their associated physical objects in the multiple set of pallets. In operation 710, the computing system can transmit a first set of instructions instructing the 3D printing device to fabricate one or more divider walls (e.g., contoured divider wall walls 300 as shown in FIGS. 3A-B) extending from either the floor of the storage volume to the top wall of the storage volume or between the first side wall and the second side wall of the storage volume, each divider wall having a contour shape of the items along an edge of each set of pallets.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A system for fabricating contoured divider walls, the system comprising:
a vehicle trailer including a storage volume formed by a floor, a top wall, a first side wall, a second side wall and a back wall, the storage volume configured to store a plurality of pallets, each pallet configured to support a plurality of physical objects of various shapes and sizes;
a plurality of sensors disposed within or with respect to the storage volume of the vehicle trailer, the plurality of sensors configured to identify physical attributes associated with the storage volume and each of the plurality of pallets;
a 3D printing device;
a computing system coupled to the plurality of sensors and the 3D printing device, the computing system configured to:
receive the physical attributes of the storage volume and each of the plurality of pallets;
divide the plurality of pallets into multiple sets of pallets based on position of each of the pallets in the storage volume;
determine a contour shape of each set of pallets of the multiple sets of pallets; and
transmit a first set of instructions instructing the 3D printing device to fabricate one or more divider walls extending from either the floor of the storage volume to the top wall of the storage volume or between the first side wall and the second side wall of the storage volume, each divider wall having the contour shape of the items along an edge of each set of pallets.

2. The system of claim 1, wherein the computing system is further configured to:
transmit a second set of instructions instructing the 3D printing device to fabricate a coupling device to be mounted on two or more pallets of the plurality pallets, wherein each coupling device mounted on each pallet is configured to couple with a different coupling device mounted on a different pallet.

3. The system of claim 2, wherein the storage volume further includes a door configured to open and close to provide and restrict access to the storage volume.

4. The system of claim 3, wherein the storage volume further includes an attachment device disposed on the first side wall, second side wall, back wall, and door.

5. The system of claim 4, wherein one or more coupling devices mounted to one or more pallets of the plurality of pallets are configured to couple with the attachment device disposed on the first side wall, second side wall, back wall, and door.

6. The system of claim 1, wherein each divider wall is configured to prevent the physical objects disposed on each pallet of each of the sets of pallets from tipping or spilling.

7. The system of claim 1, wherein the plurality of physical objects are aligned laterally and stacked vertically along each of the pallets.

8. The system of claim 7, wherein the computing system is configured to:
transmit a third set of instructions instructing the 3D printing device to fabricate one or more panels for each pallet of the plurality of pallets based on the contour shape of each pallet, the one or more panels configured to enclose an outside of each pallet supporting the plurality of physical objects.

9. The system of claim 8, wherein the one or more panels extend along the length of each pallet and the plurality of physical objects are stacked vertically on each pallet.

10. The system of claim 9, wherein one or more panels includes at least one panel for each side of each pallet.

11. A method for fabricating contoured divider walls, the method comprising:
storing, via storage volume formed by a floor, a top wall, a first side wall, a second side wall and a back wall of a vehicle trailer a plurality of pallets, each pallet configured to support a plurality of physical objects of various shapes and sizes;
identifying, via a plurality of sensors disposed within or with respect to the storage volume of the vehicle trailer, physical attributes associated with the storage volume and each of the plurality of pallets;
receiving, via a computing system, coupled to the plurality of sensors and a 3D printing device, the physical attributes of the storage volume and each of the plurality of pallets;
dividing, via the computing system, the plurality of pallets into multiple sets of pallets based on position of each of the pallets in the storage volume;
determining, via the computing system, a contour shape of each set of pallets of the multiple sets of pallets; and
transmitting, via the computing system, a first set of instructions instructing the 3D printing device to fabricate one or more divider walls extending from either the floor of the storage volume to the top wall of the storage volume or between the first side wall and the second side wall of the storage volume, each divider wall having the contour shape of the items along an edge of each set of pallets.

12. The method of claim 11, further comprising:
transmitting, via the computing system, a second set of instructions instructing the 3D printing device to fabricate a coupling device to be mounted on two or more pallets of the plurality pallets, wherein each coupling device mounted on each pallet is configured to couple with a different coupling device mounted on a different pallet.

13. The method of claim 12, wherein the storage volume further includes a door configured to open and close to provide and restrict access to the storage volume.

14. The method of claim 13, wherein the storage volume further includes an attachment device disposed on the first side wall, the second side wall, the back wall, and the door.

15. The method of claim 14, wherein one or more coupling devices mounted to one or more pallets of the plurality of pallets are configured to couple with the attachment device disposed on the first side wall, second side wall, back wall, and front door.

16. The method of claim 11, wherein each divider wall is configured to prevent the physical objects disposed on each pallet of each of the sets of pallets from tipping or spilling.

17. The method of claim 11, wherein the plurality of physical objects are aligned laterally and stacked vertically along each of the pallets.

18. The method of claim 17, further comprising:
transmitting, via the computing system, a third set of instructions instructing the 3D printing device to fabricate one or more panels for each pallet of the plurality of pallets based on the contour shape of each pallet, the one or more panels configured to enclose an outside of each pallet supporting the plurality of physical objects.

19. The method of claim 18, wherein the one or more panels extend along the length of each pallet and the plurality of physical objects are stacked vertically on each pallet.

20. The method of claim 19, wherein one or more panels include at least one panel for each side of each pallet.
